(19) United States
(12) Patent Application Publication
(10) Pub. No.: US 2013/0080291 A1
(43) Pub. Date: Mar. 28, 2013

(54) SYSTEM AND METHOD FOR COLLECTING, ORGANIZING AND PRESENTING VEHICLE HISTORY INFORMATION

(71) Applicant: Aravind Musuluri, Birmigham, AL (US)

(72) Inventor: Aravind Musuluri, Birmigham, AL (US)

(21) Appl. No.: 13/625,866

(22) Filed: Sep. 24, 2012

Related U.S. Application Data
(60) Provisional application No. 61/538,949, filed on Sep. 26, 2011.

(51) Int. Cl. G06Q 30/00

(52) U.S. Cl. 705/26.62

(57) ABSTRACT

A system for collecting, organizing and presenting vehicle history information comprises for each vehicle gathering images, audio data and video data relating to the vehicle or the vehicle history events and presenting the gathered data for the vehicle to the user in response to the user request for vehicle history information relating to the vehicle.

### CROSS REFERENCE TO RELATED APPLICATION

This application claims priority to U.S. Provisional Application Ser. No. 61/538,949 entitled System and Method for Collecting, Organizing and Presenting Vehicle History Information, filed on Sep. 26, 2011, which is incorporated herein by reference.

### FIELD OF THE INVENTION

The present invention generally relates to methods and systems for collecting, organizing and presenting vehicle history information.

### BACKGROUND

The statements in this section merely provide background information related to the present disclosure and may not constitute prior art.

Vehicle buyers may be interested in used vehicles for a variety of reasons. Unlike while buying a new vehicle, a buyer of a used vehicle may consider information about the used vehicle's past, as it can indicate issues with the vehicle's safety, reliability and value.

A typical source of past information about a vehicle is a vehicle history report available from multiple vehicle history information services such as AutoCheck® and Carfax®. Vehicle history data for a vehicle in a vehicle history report generally consists of zero or more vehicle history records relating to the vehicle typically presented in a chronological order. Vehicle history reports may include title records, accident records, theft records, and salvage and total loss records. A typical vehicle history record consists of several fields. Typical fields include date of an event, source of the record, and a brief description relating to the event.

Vehicle history information services typically gather vehicle history data from multiple sources including state Department of Motor Vehicles (DMV), fire and police departments, car dealerships and auto auctions.

One of the reasons why vehicle history reports are deficient is because they fall short in presenting vehicle history event details. A short description about a vehicle history event as presented in current vehicle history reports, while is helpful in understanding some facts about the event quickly, leaves the user of the vehicle history report wanting for more details. For example, two vehicles with rear-end collisions may not sustain the same damages. Merely reporting a rear-end collision is not enough as it doesn't help in understanding the extent of the damages. Moreover, some vehicle history events may not be fully conveyed with just words. Thus, looking at only vehicle history reports, two vehicles may be similar, but in reality they may differ significantly in terms of safety, reliability and value.

In view of the above drawback(s), there remains an unfulfilled need for a better vehicle history report.

### SUMMARY

The following presents a simplified summary of the invention in order to provide a basic understanding of some aspects of the invention. The summary is not an extensive overview of the invention. It is not intended to identify key elements of the invention or to delineate the scope of the invention. Its sole purpose is to present some concepts of the invention in a simplified form as a prelude to the more detailed description that is presented later.

The invention described here as well as the descriptions of prior art are equally applicable to vehicle history reports in print or electronic format.

A vehicle history report may include vehicle history records pertaining to more than one vehicle. Thus, while our disclosure and the examples of use given herein are sometimes described in terms of a vehicle history report with vehicle history records pertaining to a single vehicle, this is to be understood to be an example of the use and utility of the inventions, and is not intended to imply any limitation in the scope of their use.

The present invention generally relates to methods and systems for collecting, organizing and presenting vehicle history information. More particularly, it relates to methods for gathering images, audio data, video data and multimedia data (hereinafter referred to as “visual data”) relating to vehicles or vehicle history events. A further object of the present invention is to supply vehicle history information for a vehicle incorporating the gathered visual data for the vehicle to a user in response to the user search query for vehicle history information relating to the vehicle.

### DESCRIPTION OF THE DRAWINGS

FIG. 1 depicts an exemplary system for collecting, organizing and presenting vehicle history information in accordance with an embodiment of the present disclosure.

FIG. 2 depicts an exemplary vehicle history service computing device of the system depicted in FIG. 1.

FIG. 3 depicts an exemplary graphical user interface (GUI) that may be presented to the user by the vehicle history service computing device of FIG. 2.

FIG. 4 depicts an exemplary vehicle history report created by the vehicle history service computing device of FIG. 2.

FIG. 5 depicts an exemplary photograph from the vehicle history report of FIG. 4.

### DETAILED DESCRIPTION

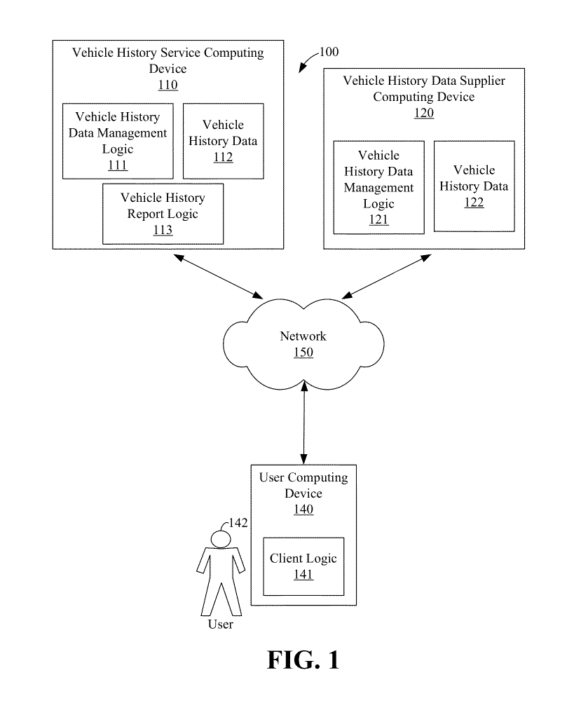

FIG. 1 depicts a vehicle history system 100 for collecting, organizing and presenting vehicle history information in accordance with an embodiment of the present disclosure. The vehicle history system 100 comprises a vehicle history service computing device 110, a vehicle history data supplier computing device 120, and a user computing device 140. The vehicle history service computing device 110, the vehicle history data supplier computing device 120, and the user computing device 140 all communicate over the network 150.

The network 150 can include any type of network known in the art or future developed. In this regard, the network 150 may be an Ethernet, a local area network (LAN), or a wide area network (WAN), e.g., the Internet, or a combination of networks.

Further, the network 150 may use any protocol or technology developed or future developed for the purpose of transmitting or communicating data such as, but not limited to, HTTP, HTTPS, FTP, File, TCP/IP and POP3. Thus, while our disclosure and the examples of use given herein are sometimes described in terms of HTTP and TCP/IP, this is to be understood to be an example of the use and utility of the disclosure, and is not intended to imply any limitation in the scope of their use.

The data transmitted over the network 150 may be in any format or language know in the art or future developed such as, but not limited to, HTML, JSON, TXT, CSS, XHTML, PDF, E-mail, DOC, XML, JPEG, TIFF, PNG, GIF, DJVU, MPEG, VOB, MKI and AVI. Thus, while our disclosure and the examples of use given herein are sometimes described in terms of HTML, this is to be understood to be an example of the use and utility of the disclosure, and is not intended to imply any limitation in the scope of their use.

The user computing device 140 may be any type of device that is capable of receiving data input from a user 142, processing the data, and transmitting the data over the network 150. In addition, the user computing device 140 is capable of receiving data from the network 150, processing the received data, and displaying the processed data via a display device (not shown).

In one embodiment, the user computing device 140 is a personal computer (PC). However, the user computing device 140 may be other types of devices that communicatively couple to the network 150, including, for example, a laptop computer, or a tablet computer, or a video game console, or a handheld device, such as a personal digital assistant (PDA) or a cell phone.

Note that, for simplicity, only one user computing device 140 is shown in the exemplary system 100. However, the system 100 may include more user computing devices 140 that connect additional users to the vehicle history service computing device 110.

The vehicle history service computing device 110 acquires vehicle history data from a variety of data suppliers. In this regard, the system 100 further comprises a vehicle history data supplier computing device 120 that is communicatively coupled to the network 150. The vehicle history data supplier computing device 120 may be, for example, but not limited to, a government agency computing device, an insurance company computing device, a dealer computing device, an auction computing device, an enterprise or firm computing device, a data aggregation company computing device, or a vehicle owner computing device. The vehicle history data supplier computing device 120 comprises a vehicle history data management logic 121 that manages vehicle history data 122.

Note that, for simplicity, only one vehicle history data supplier computing device 120 is shown in the exemplary system 100. However, the system 100 may include more vehicle history data supplier computing devices 120 that connect additional vehicle history data suppliers to the vehicle history service computing device 110.

The exemplary vehicle history service computing device 110 comprises vehicle history data management logic 111 and vehicle history report logic 113 along with vehicle history data 112.

In the exemplary vehicle history service computing device 110, the vehicle history data management logic 111 communicates with the vehicle history data management logic 121 of the vehicle history data supplier computing device 120 requesting vehicle history data on a periodic basis or as needed. Upon receiving the request for data from the vehicle history data management logic 111, the vehicle history data management logic 121 extracts data from the vehicle history data 122 and transmits the vehicle history data 122 to vehicle history data management logic 111, which updates the vehicle history data 112 with the downloaded vehicle history data 122.

In another embodiment, the vehicle history data management logic 111 from time-to-time polls the vehicle history data management logic 121 to determine if any updates have been made to the vehicle history data 122. If there have been updates to the vehicle history data 122, the vehicle history data management logic 111 requests from the vehicle history data management logic 121 updated vehicle history data 122. In response, the vehicle history data management logic 121 retrieves updated data from the vehicle history data 122 and transmits the vehicle history data 122 to the vehicle history data management logic 111, which updates the vehicle history data 112 with the downloaded vehicle history data 122.

In yet another embodiment, the vehicle history data management logic 121 of the vehicle history data supplier computing device 120 communicates with the vehicle history data management logic 111 of the vehicle history service computing device 110 on a periodic basis or when updates have been made to the vehicle history data 122. In this regard, the vehicle history data management logic 121 retrieves updated data from the vehicle history data 122 and transmits the vehicle history data 122 to the vehicle history data management logic 111, which updates the vehicle history data 112 with the received vehicle history data 122.

In yet another embodiment, if the vehicle history data 122 is already available in the memory of the vehicle history service computing device 110, e.g., through a compact disc (CD) created by the vehicle history data supplier computing device 120, then the network 150 and the time-to-time polls to the vehicle history data management logic 121 are optional.

Note that each item of vehicle history data 122 transmitted by the vehicle history data management logic 121 and acquired by the vehicle history data management logic 111 and stored in the vehicle history data 112 is associated with a particular vehicle identification data and thus a particular vehicle. In the exemplary embodiment of the present disclosure, the vehicle identification data is a seventeen character alphanumeric string, commonly referred to as vehicle identification number (VIN), used by the automotive industry to identify individual motor vehicles. In other embodiments, other vehicle identification data known in the art or future-developed may be used to identify individual motor vehicles.

Note that an item of vehicle history data 122 transmitted by the vehicle history data management logic 121 to the vehicle history data management logic 111 and stored in the vehicle history data 112 may be visual data associated with a VIN or visual data relating to a vehicle history event which is associated with a VIN.

Further note that an item of vehicle history data 122 transmitted by the vehicle history data management logic 121 to the vehicle history data management logic 111 and stored in the vehicle history data 112 may be an identifier identifying a resource/document comprising of visual data associated with a VIN or an identifier identifying a resource/document comprising of visual data relating to a vehicle history event which is associated with a VIN. In the exemplary embodiment of the present disclosure, the identifier is a Uniform Resource Locator or Universal Resource Locator (URL), used by the computing industry to specify where a known resource is available on the Internet and the mechanism for retrieving it. In other embodiments, other identifiers known in the art or future-developed may be used to identify visual data.

Examples of visual data for a vehicle may include, but not limited to, one or more photographs of the vehicle showing damages sustained by the vehicle in an accident, audio/video recording of the vehicle being auctioned off, photographs of the vehicle at an auction, photographs of the vehicle at a dealer, one or more photographs of the vehicle before, during and/or after a repair or service, an audio/video recording of the repair work or service performed on the vehicle, an audio/video recording with closed captions of the summary of the repair work or service performed on the vehicle, photographs of the vehicle at a particular instance of time, rendered images of the vehicle at a particular instance of time, and multimedia description of the vehicle at a particular instance of time.

The visual data transmitted by the vehicle history data management logic 121 and acquired by the vehicle history data management logic 111 and stored in the vehicle history data 112 may be in any format or language know in the art or future developed such as, but not limited to, HTML, JSON, TXT, CSS, XHTML, PDF, DOC, XML, JPEG, TIFF, PNG, GIF, DJVU, MPEG, VOB, MKI and AVI.

In one embodiment, visual data associated with a particular VIN and transmitted by the vehicle history data management logic 121 of the vehicle history data supplier computing device 120 to the vehicle history data management logic 111 may contain vehicle identification data with in the visual data itself. For example, a photograph of a vehicle taken in such a way that it captures the VIN imprinted on the vehicle. Another example, may be, a video recording of a vehicle showing the VIN of the vehicle as part of the video recording.

In one embodiment, the vehicle history data management logic 111 may redact or censor visual data transmitted by the vehicle history data management logic 121 to remove information not relevant to understanding the vehicle. The redacted data may be, for example, personal information and may be censored because of privacy concerns.

In yet another embodiment, the visual data transmitted by the vehicle history data management logic 121 may be vetted by a moderator.

Further note that the vehicle history data management logic 121 while transmitting the visual data to the vehicle history data management logic 111 may include metadata that may provide additional details about the visual data. Example metadata may include, but not limited to, data and time when the visual data is created, a description or comment about the visual data, and the source of the visual data. In one embodiment, the vehicle history data management logic 111 may store the metadata along with the visual data in the vehicle history data 112.

Note that the disclosure may also be practiced in a distributed computing environment where tasks or instructions of the vehicle history service computing device 110, vehicle history data supplier computing device 120, and user computing device 140 are performed by multiple computing devices communicatively coupled to the network.

In one embodiment, a user 142 through the client logic 141 running on the user computing device 140 may enter a search query consisting of vehicle identification data for one or more vehicles for which the user is interested in receiving vehicle history information.

The client logic 141 may comprise, for example, an Internet browser; however, other types of client logic 141 for interfacing with the user 142 and for communicating with the vehicle history report logic 113 may be used in other embodiments of the present disclosure.

The client logic 141 transmits the user search query to the vehicle history service computing device 110 via the network 150. Upon receiving the user search query the vehicle history report logic 113 examines the vehicle history data 112 to determine whether it contains any vehicle history data that match the vehicle(s) identified by the vehicle identification data in the user search query. If so, the vehicle history report logic 113 extracts vehicle history data matching the vehicle(s) identified by the vehicle identification data in the user search query from the vehicle history data 112 and compiles from the extracted vehicle history data a chronological list of vehicle history records grouped by each vehicle in the user search query and returns the list to the client logic 141, which displays the results to the user 142 in a window.

In another embodiment, upon receiving the user search query from the client logic 141, the vehicle history report logic 113 examines the vehicle history data 112 to determine whether it contains any visual data for the vehicle(s) identified by the vehicle identification data in the user search query. If so, the vehicle history report logic 113 extracts the visual data matching the vehicle(s) identified by the vehicle identification data in the user search query from the vehicle history data 112 and compiles a report and returns the report to the client logic 141, which displays the report to the user 142 in a window.

In yet another embodiment, upon receiving the user search query from the client logic 141, the vehicle history report logic 113 examines the vehicle history data 112 to determine whether it contains any vehicle history data that match the vehicle(s) identified by the vehicle identification data in the user search query. Upon examination, the vehicle history report logic 113 creates a report indicating the presence or absence visual data for each vehicle in the user search query and returns the report to the client logic 141, which displays the report to the user 142 in a window. In yet another embodiment, upon examination, the vehicle history report logic 113 may create a report indicating not only the presence or absence of visual data for each vehicle in the user search query but also the count of visual data found for each vehicle. The report is then transmitted to the client logic 141, which displays the report to the user 142 in a window.

Note that in one embodiment, the vehicle history information transmitted to the client logic 141 by the vehicle history report logic 113 and displayed to the user 142 may contain identifiers to resources comprising of visual data and the client logic 141 may retrieve and show the corresponding resource with visual data to the user 142 in place of or in addition to the identifiers.

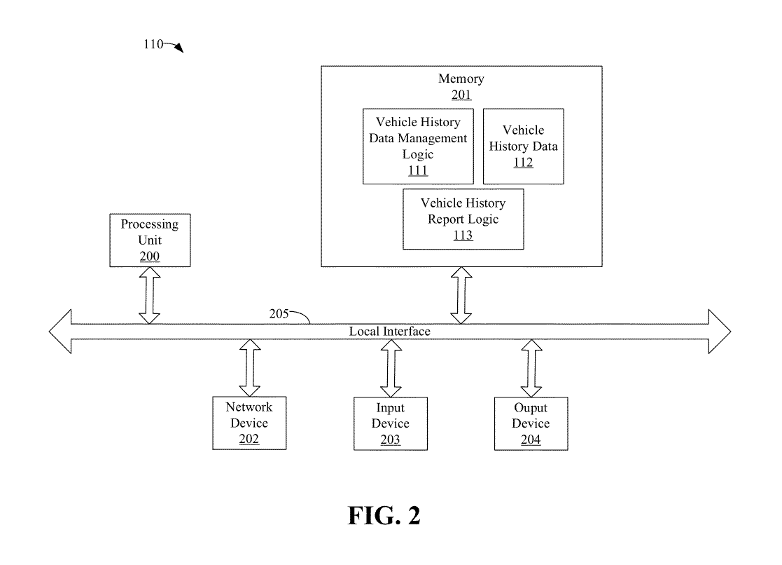

FIG. 2 depicts an exemplary vehicle history service computing device 110 in accordance with an embodiment of the present disclosure. The vehicle history service computing device 110 is only one example of a suitable computing environment and it is not intended to suggest any limitation as to the scope of use or functionality of the disclosure.

The exemplary embodiment of the vehicle history service computing device 110 depicted by FIG. 2 includes a processing unit 200, memory 201, a network device 202, one or more input devices 203, and one or more output devices 204.

The vehicle history service computing device 110 further comprises the vehicle history data management logic 111, and the vehicle history report logic 113. The vehicle history data management logic 111 and the vehicle history report logic 113 may be implemented in software, firmware, hardware, or any combination thereof. In the exemplary vehicle history service computing device 110 depicted by FIG. 2, the vehicle history data management logic 111 and the vehicle history report logic 113 are implemented in software and stored in memory 201.

In addition, the vehicle history service computing device 110 further comprises the vehicle history data 112. The vehicle history data 112 comprises data indicative of a plurality of vehicle identification data and associated with each vehicle identification data are a set of vehicle history records relating to the vehicle identified by the vehicle identification data. In the exemplary vehicle history service computing device 110 depicted by FIG. 2, the vehicle history data 112 is stored in memory 201.

The processing unit 200 comprises processing hardware for executing instructions stored in memory 201. The processing unit 200 further communicates to and drives the other elements within the vehicle history service computing device 110 via a local interface 205, which can include at least one bus. Note that the processing unit 200 may be a digital processor (DSP) or other type of circuitry configured to run and/or execute the instructions contained in the vehicle history data management logic 111, and the vehicle history report logic 113.

The memory 201 may be any type of computer memory known the art or future-developed for electronically storing data and/or logic, including volatile and non-volatile memory. In this regard, memory 201 can include random access memory (RAM), read-only memory (ROM), flash memory, any magnetic computer storage device, including hard disks, floppy discs, or magnetic tapes, and optical discs.

The network device 202 may be any type of network device (e.g., a modem) known in the art or future-developed for communicating over the network 150 (FIG. 1). In this regard, the vehicle history service computing device 110 communicates with the vehicle history data supplier computing device 120 (FIG. 1), and the user computing device 140 (FIG. 1) over the network 150 via the network device 202.

The input device 203 is any type of input device known in the art or future-developed for receiving data. As an example, the input device 203 may be a keyboard, a mouse, a touch screen, a serial port, a scanner, a camera, or a microphone. Notably, only one input device 203 is shown in FIG. 2; however, the system 110 may include additional input devices in another embodiment.

The output device 204 is any type of output device known in the art or future-developed for displaying data. As an example, the output device 204 may be a liquid crystal display (LCD) or other type of video display device, a speaker, or a printer. Notably, only one output device 204 is shown in FIG. 2; however, the system 110 may include additional output devices in another embodiment.

The vehicle history service computing device 110 (FIG. 1) may offer a variety of ways by which the user 142 (FIG. 1) may request vehicle history data.

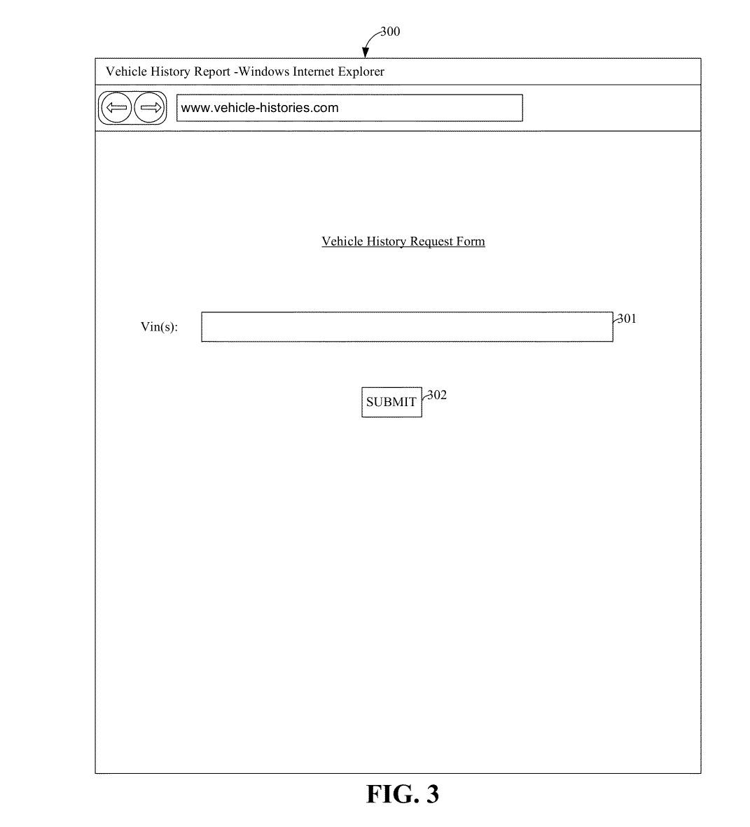

FIG. 3 depicts an exemplary GUI 300 form that is generated and made available by the vehicle history report logic 113 (FIG. 1) to be displayed to the user 142 (FIG. 1) by the client logic 141 (FIG. 1). The GUI 300 comprises a text area 301 for entering one or more vehicle identification data for which the user 142 (FIG. 1) desires to find vehicle history information. In addition, the GUI 300 comprises a submit button 302 which when clicked or selected results in the client logic 141 (FIG. 1) transmitting the search query consisting of the text entered by the user 142 (FIG. 1) in the text field 301 to the vehicle history report logic 113 (FIG. 1) via the network 150 (FIG. 1).

Note that the form fields described hereinabove are for exemplary purposes only. Other form fields may be used in other embodiments of the present disclosure for the user 141 (FIG. 1) to further specify additional parameters, conditions or input data that may be used by the vehicle history report logic 113 (FIG. 1) to customize the generated vehicle history report. The additional parameters, conditions or input data may be, for example, user identification data and payment data.

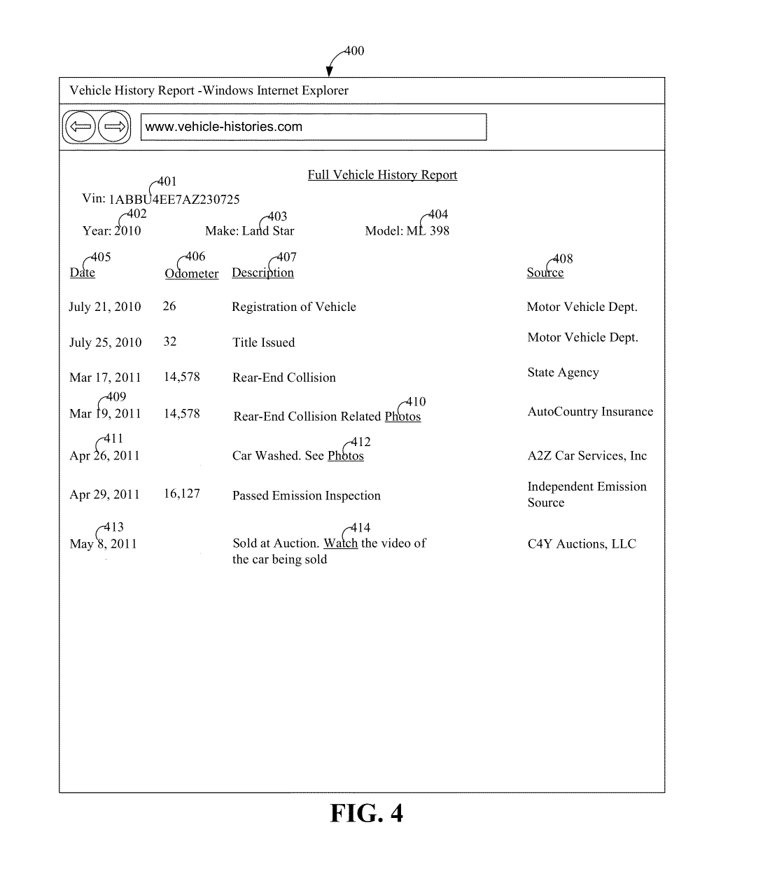

The present invention is now described with reference to exemplary report 400 in FIG. 4. Assume for illustration purposes that the user 142 (FIG. 1) is interested in vehicle history data for a vehicle identified by the VIN “1ABBU4EE7AZ230725” and further assume that the user 142 (FIG. 1) entered “1ABBU4EE7AZ230725” into the text field 301 (FIG. 3) and clicked the submit button 302 (FIG. 3). In response to the user clicking the submit button 302 (FIG. 3), the client logic 141 (FIG. 1) creates and transmits a search query consisting of the vehicle identification data “1ABBU4EE7AZ230725” to the vehicle history report logic 113 (FIG. 1) via the network 150 (FIG. 1). Upon receiving the search query, the vehicle history report logic 113 (FIG. 1) creates a vehicle history report reading or otherwise accessing vehicle history data 112 (FIG. 1) for the vehicle identified by the VIN “1ABBU4EE7AZ230725” and transmits the vehicle history report as response back to the client logic 141 (FIG. 1) via the network 150 (FIG. 1). Further, for illustration purposes, assume that report 400 consists of the vehicle history report for the vehicle identified by the VIN “1ABBU4EE7AZ230725” displayed by the client logic 141 (FIG. 1) to the display device (not shown) of the user computing device 140 (FIG. 1) as a result of the response received by the client logic 141 (FIG. 1) from the vehicle history report logic 113 (FIG. 1).

In this regard, exemplary report 400 consists of a header section identifying the vehicle 401, which in the exemplary report is “1ABBU4EE7AZ230725.” In addition, the header section consists of optional vehicle details year 402, make 403, and model 404 for the vehicle identified by the VIN 401. Note that in other embodiments of the present disclosure, the header section may contain other details regarding the vehicle, information about the report and/or educational material.

Exemplary report 400 further consists of a detail section comprising vehicle history records arranged in a tabular format with each row other than the header row indicative of a vehicle history record. The table may include a date column 405 indicating the date of the vehicle history event, an odometer column 406 providing the odometer reading, a description column 407 providing a description, and a source column 408 indicating the source of the vehicle history record. Note that in other embodiments of the present disclosure, the vehicle history records may be presented in other formats, for example, as a list. Further note that additional or fewer columns representing other data associated with a vehicle history record may be included in other embodiments of the present disclosure.

The vehicle history event dated “Mar 19, 2011” 409 contains rear-end collision related photos and the user may click on the photos 410 link to view the photos. The photos of the vehicle after car wash on “Apr 26, 2011” 411 are available as part of the vehicle history report and the user may click on the photos 412 link to view them. The vehicle history event dated “May 8, 2011” 413 includes a watch 414 link to the video of the vehicle being sold at an auction.

Note that while the vehicle history records in the report 400 are presented in a chronological order, however, in other embodiments the vehicle history records may be presented in a different order.

Note that in one embodiment of the present disclosure, an option may be provided to the user where in the user may download or view all the visual data by clicking or selecting a single option. In another embodiment, an option may be provided to the user where in the user may download or view all the visual data of a particular type, for example, photographs, by clicking or selecting a single option.

Note that in one embodiment of the present disclosure, a score may be calculated for the vehicle based on the visual data in the vehicle's vehicle history report and presented as part of the vehicle history report to the user 142 (FIG. 1).

Note that while the exemplary report 400 is in HTML, the vehicle history report logic 113 (FIG. 1) may create vehicle history reports in any format or language know in the art or future developed such as, but not limited to, JSON, TXT, CSS, XHTML, PDF, E-mail, DOC and XML.

Note that in one embodiment of the present disclosure, the user 142 (FIG. 1) may be required to pay a fee to access the report 400.

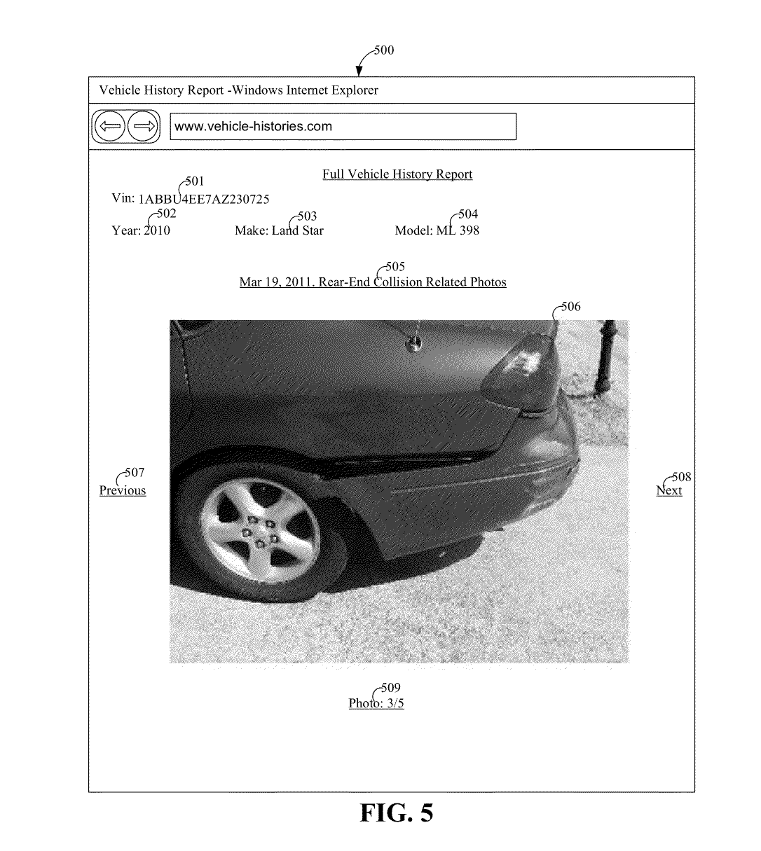

The present invention is now described with reference to GUI 500 in FIG. 5. Assume for illustration purposes that the user 142 (FIG. 1) is viewing the report 400 (FIG. 4) and is interested in seeing rear-end collision photos that were taken on “Mar 19, 2011” 409 (FIG. 4) and further assume that the user clicked on the photos 410 (FIG. 4) link. In response to the user 142 (FIG. 1) clicking on the photos 410 (FIG. 4) link, the client logic 141 (FIG. 1) requests vehicle history report logic 113 (FIG. 1) for rear-end collision photos taken on “Mar 19, 2011” 409 (FIG. 4). The vehicle history report logic 113 (FIG. 1) in turn exacts the rear-end collision photos from the vehicle history data 112 (FIG. 1) and transmits the photos to the client logic 141 (FIG. 1) which may display the photos to the user 142 (FIG. 1) as shown in GUI 500.

Exemplary GUI 500 consists of a header section identifying the vehicle 501, which in the exemplary report is “1ABBU4EE7AZ230725.” In addition, the header section consists of optional vehicle details year 502, make 503, and model 504 for the vehicle identified by the VIN 501. Note that in other embodiments of the present disclosure, the header section may contain other details regarding the vehicle, information about the report and/or educational material.

In the exemplary GUI 500, the rear-end collision photos are shown as a slideshow. The slideshow consists of the title 505, the current photo 506 and previous 507 and next 508 links to access rest of the rear-end collision photos. The metadata 509 associated with the photo 506 indicating that the photo is the third one in a series of five photos is show at the bottom of the photo 506.

Note that the client logic 141 (FIG. 1) may display the visual data in a variety of ways. In another embodiment, the visual data may be embedded and displayed within the GUI 400 (FIG. 4).

Although the present disclosure has been described with respect to a specific preferred embodiment thereof, various changes and modifications may be suggested by one skilled in the art and it is intended that the present disclosure encompass such changes and modifications as fall within the scope and spirit of the disclosure.

What is claimed is:

1. A system for creating vehicle history report for a vehicle, comprising:
entering into the system a vehicle identifier for the vehicle, wherein the vehicle identifier enables the system to identify the vehicle and distinguish the vehicle from every other vehicle;
entering into the system visual data relating to the identified vehicle and correlating the visual data with the vehicle identifier in the system;
receiving search query data from a user wherein the search query data comprises at least one vehicle identifier;
generating a report in response to the search query that includes the visual data for the identified vehicle; and
providing the user with access to the report.

2. The method of claim 1, wherein the visual data includes image data, audio data and/or video data.

3. The method of claim 1, wherein the visual data includes an identifier to image data, audio data and/or video data.

4. The method of claim 1, wherein the visual data includes an identifier to a resource comprising of image data, audio data and/or video data.

5. The method of claim 1, wherein the generating the report step further comprises presenting the visual data in the form of a slide show.

6. The method of claim 1, wherein the generating the report step further comprises presenting the visual data next to the corresponding vehicle history event.

7. The method of claim 1, wherein the generating the report step further comprises including advertisement data.
